(19) United States
(12) Patent Application Publication
(10) Pub. No.: US 2002/0131059 A1
(43) Pub. Date: Sep. 19, 2002

(54) Printer controller, data processing method and control program

(76) Inventor: Naoki Tsuchitoi, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/082,300

(22) Filed: Feb. 26, 2002

(30) Foreign Application Priority Data
Mar. 2, 2001 (JP) 058245/2001 (PAT.
Feb. 18, 2002 (JP) 040017/2002 (PAT.

(51) Int. Cl. B41J 1/00

(52) U.S. Cl. 358/1.1

(57) ABSTRACT

To provide a charge system that is reliable in the case where a printer at a shop provides a print service for printing print data transferred from a host computer of a user. Also, to provide a print service that can keep secrecy of the print data, in which the print data of a certain user is prevented from being simply appropriated by other users, or printed in accordance with an instruction of other users.

### BACKGROUND OF THE INVENTION

1. Field of the Invention

The present invention relates to a printer controller that can communicate via an Internet to effect a printing process and a charge process at a print service shop, a server for transferring data to the printer controller to perform the printing process, or a printing system composed of the printer controller and the server.

2. Related Background Art

Conventionally, it was difficult for the user in person to own an intelligent office machine that could make an image processing in a SOHO (Small Office Home Office) environment, for example, even though the user wanted to employ the office machine due to cost and space. Therefore, there is a service form in which such an office machine is installed at a shop and the user is charged according to the amount of use.

For instance, a copying machine is installed at a shop such as a convenience store, and the user pays the shop for a service fee according to the number of copies.

In the copying machine, since a manuscript for copying already exists physically, the user only needs to take it to the shop to receive the service.

However, in a service for providing the printing apparatus (printer) that prints print data produced by a host computer, because the print data is not physical, the user must store the print data in a physical medium (storage medium) such as a floppy disk, and take it to the shop. However, the storage medium has various types such as a floppy disk, an optical magnetic disk, a CD-ROM, a DVD, and a flash media that can mediate a PCMCIA, and it is not realistic in the cost and the maintenance that the printer can cope with all the storage media.

Nowadays, the Internet has become more popular, while the connection cost of the Internet has been reduced. It has become realistic in respect of the cost to connect the printer installed at the shop to the Internet.

Accordingly, the user produces the print data in a host computer connected to the Internet, transfers the print data from the host computer via the Internet to the printer installed at the shop, and thereby can accept the service efficiently without copying any print data onto the storage medium.

### SUMMARY OF THE INVENTION

However, if the printer is simply connected to the Internet, there are following problems.

First of all, there is a charge problem. When the printer at the shop prints the print data transferred from the host computer, the printed matter is output before a print charge is paid. Namely, the charge method is ambiguous unlike a system such as a copying machine in which the copy charge is paid before copying.

In this regard, there is an accounting system in which the user registration and the issuance of a user ID are made and the user ID is charged at a stage of transmitting the print data the printer at the shop. However, this accounting system needs in advance a complex procedure for making the account, and is less convenient for the user.

Further, there is an approval problem. For example, when the print data is transferred from a plurality of users to the printer at the shop, it is difficult to assort the printed matter for each user, if there is no means for approving the user of each print data, and there is the possibility that the printed matter is appropriated by another user.

Moreover, there is a privacy problem. Some printed matters are highly secretive, and it is unpreferable in respect of privacy protection that the contents of printed matter may be scrutinized by the unspecific user.

Thus, it is an object of the present invention to provide a charge system that is reliable in the case where a print service for printing the print data transferred from the host computer of the user is provided by the printer at the shop.

Also, it is another object of the invention to provide a print service in which the print data for a certain user is prevented from being simply appropriated by another user, or printed in accordance with an instruction of another user, thereby keeping the secrecy of the print data.

### BRIEF DESCRIPTION OF THE DRAWINGS

FIG. 1 is a block diagram for explaining a configuration of a printer system;

FIG. 2 is a table for explaining a configuration of table information generated by a job management section;

FIG. 3 is a flowchart showing one example of a first data processing procedure according to the present invention;

FIG. 4 is a view showing an input screen displayed on an operation panel;

FIG. 5 is a view showing a selection screen displayed on the operation panel;

FIG. 6 is a block diagram for explaining the configuration of a printer system;

FIG. 7 is a table for explaining the configuration of table information generated by the job management section;

FIG. 8 is a flowchart showing one example of a second data processing procedure according to the invention;

FIG. 9 is a flowchart showing one example of a third data processing procedure according to the invention;

FIG. 10 is a block diagram for explaining the configuration of a printer system;

FIG. 11 is a flowchart showing one example of a fourth data processing procedure according to the invention;

FIG. 12 is a flowchart showing one example of a fifth data processing procedure according to the invention; and

FIG. 13 is a table showing a memory map of a readable storage medium in the printer system according to the invention.

### DETAILED DESCRIPTION OF THE PREFERRED EMBODIMENT

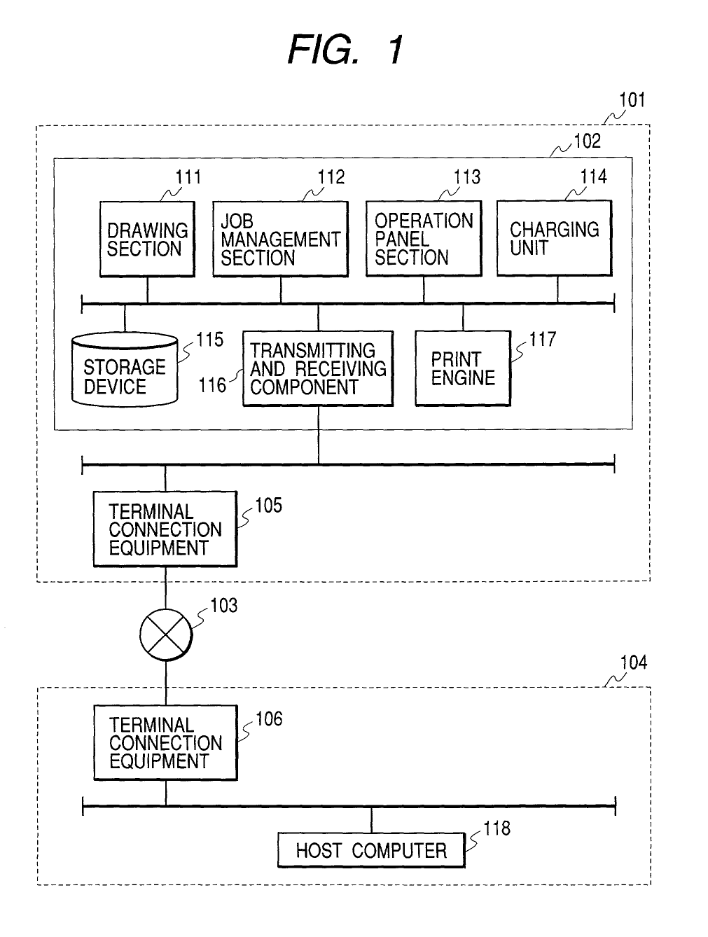

FIG. 1 is a block diagram for explaining a configuration of a printer system according to the present invention. This system is constituted of a system on an output center side (output center system) 101, a system on a user side (user system) 104, and an Internet 103 for connecting both the systems.

It is supposed that the output center system 101 and the user system 104 are usually installed at remote sites. The Internet 103 is an abstract concept, and in practice, connecting means such as ISDN, CATV, and DSL, and providers are intervened, but not required for the description of this invention, and omitted from the description.

The output center system 101 is a public installation for providing the print service, in which the print service is to print in accordance with a print request from the user who pays the compensation. For instance, the output center system is constructed at the shop such as a convenience store.

The user system 104 corresponds to a person or a company, and is possessed by the user who enjoys the print service.

The user system 104 is constituted of one or more host computers 118 in which the print data is created and the created print data is stored, and the terminal connection equipment 106 for connecting the system to the Internet.

The terminal connection equipment 106 and the host computer 118 are linked on the LAN, whereby the host computer 118 can be connected via the terminal connection equipment 106 to the Internet 103. The terminal connection equipment 106 may be means such as a modem, TA or a router as far as it enables connection to the Internet. The terminal connection equipment 106 may be contained within the host computer 118.

In FIG. 1, the output center system 101 is constituted of the terminal connection equipment 105 and a printing apparatus 102, and the terminal connection equipment 105 is the same as the terminal connection equipment 106.

The printing apparatus 102 comprises a transmitting and receiving component 116 for transmitting and receiving the print data to and from an external device, a drawing section 111 for drawing an image by analyzing and printing the received print data, a storage device 115 composed of a mass storage such as an HDD for temporarily storing the image data of the image drawn by the drawing section 111, a job management section 112 for managing a print job transmitted to the printing apparatus, an operation panel section 113 for enabling the user to enter a print instruction, a charge device 114 for notifying an amount of money input by the user to the job management section 112, and a print engine 117 for actually printing an image of the image data stored in the storage device 115 on the basis of the ink jet technique or electrophotography technique. Herein, the print job generically involves the print data and other data corresponding to the print data, with a print request for the print data.

Herein, the print service with the print system of FIG. 1 will be outlined.

The print data of the user is transmitted from the host computer 118 to the printing apparatus 102. When the print job is transmitted from the host computer 118, the host computer 118 prompts the user to input the user name, the password, and the job name (name of print data), and transmits the print job with the input contents as the attribute information of the print job attached thereto to the output center system 101.

And the print job is transmitted through the terminal connection equipment 106 via the Internet 103 to the output center system 101.

The transmitting and receiving component 116 of the printing apparatus 102 receives the print job transmitted from the host computer 118, and then distributes the attribute information to the job management section 112 and the print data to the drawing section 111. The drawing section 111 draws an image on the basis of the print data, whereby the bit map image data of the drawn image is stored as a document file for each print job in the storage device 115. The bit map image data is stored in the storage device 115 so that the printed matter is output promptly upon a print instruction from the user. However, if the storage capacity of the storage device 115 is reduced preferentially, the storage device 115 may store the print data described in PDL (Page Description Language), and the drawing section 111 may draw the print data in PDL format, when printing, to generate the bit map image data.

Also, the attribute information is passed to the job management section 112, and stored in a table information by the job management section 112.

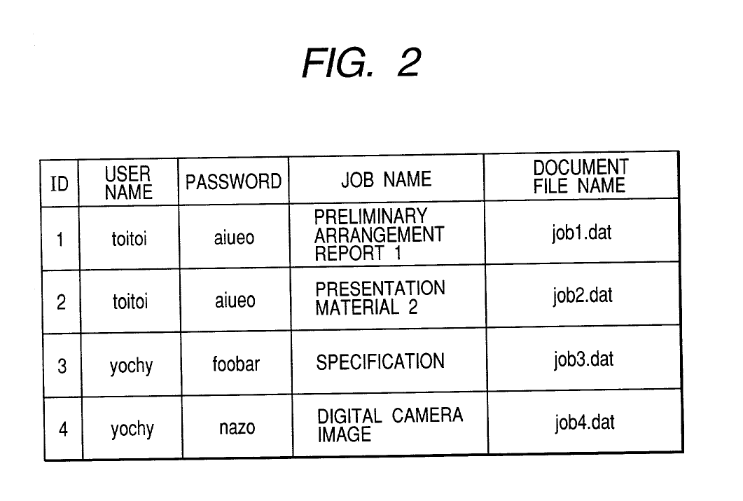

FIG. 2 is a table for explaining the configuration of the table information produced by the job management section 112 as shown in FIG. 1.

In FIG. 2, the table information holds four parameters, the user name, the password, the job name and the document file name, for each print job. This table information is written in the storage device 115 that is a non-volatile memory not to disappear due to an abrupt power failure of the printing apparatus 102. In the table information of FIG. 2, “ID” indicates the print job ID for identifying the print job.

Herein, the user name, the password and the job name are input through a user interface (UI) by the user when the print job is transmitted from the host computer 118. The document file name is a unique name generated by the job management section 112, when the print job is input into the printing apparatus 102. When a particular document file is specified from among a plurality of document files stored in the storage device 115, this document file name is used.

For the security, the password should be encrypted by the DES (Data Encryption Standard), but because there is no relation with the essential part of this embodiment, the password is supposed to be stored in original text (plain text) for the following discussion.

It is important in the above process that the user can input the print job into the printing apparatus 102 without being aware of charging. Since there is no need of making a registration operation in advance to register the user, the user can readily transmit the print job to the print center system 101.

Next, an actual printing procedure will be described.

The user transmits a print job from the user system 104, and then goes to the print center system 101 to perform the actual printing. The user firstly pays the print charge before performing the actual printing. This procedure is performed by inputting a coin, doing a service and receiving a change, like the general service of the copying machine. The charge device 114 fulfils that role, and notifies the user of a paying situation on the operation panel 113.

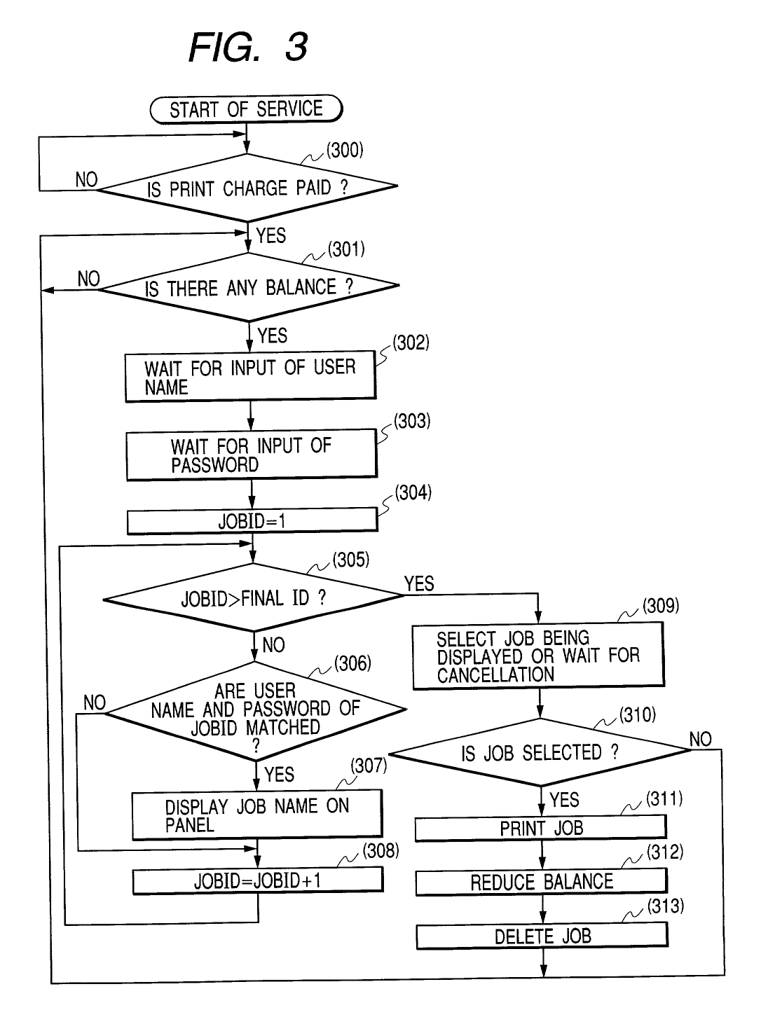

FIG. 3 is a flowchart showing one example of a first data processing procedure in the printing apparatus according to the invention. Numerals (300) to (313) denote each step.

This process is started upon initiating the printing apparatus 102, and continues to operate till the power is shut off.

At step (300), it is determined whether or not the print charge is paid. Specifically, it is detected whether or not the coin is input, and if the coin is input, it is determined that the print charge is paid. When the print charge is paid, the balance of the print charge paid by the user is checked at. step (301). The information indicating this balance is passed from the charge device 114. If it is determined that there is no balance, the print service is not made, and the procedure returns to the top of the process.

On the contrary, if it is determined at step (301) that there is the balance, the procedure waits for an input of the user name at step (302). Checking whether or not the user name is input, if the user name is input, the procedure waits for an input of the password at step (303). Checking whether or not the password is input, if the password is input, the print job possessed by the user is retrieved.

Then, the print job is retrieved from the top of the print jobs that the printing apparatus 102 holds, and at step (304), the variable JobID is set to “1”. At step (305), it is determined whether or not the variable JobID is beyond the final ID (maximum ID of the print job that the printing apparatus 102 holds). If it is determined that the variable JobID is not beyond the final ID, referring to the attribute of the print job corresponding to the variable JobID, it is checked whether or not the user name with password of the print job is matched with the input user name with password at step (306). If they are unmatched, the procedure goes to step (308), or if they are matched, the job name is displayed on the display panel at step (307).

And the variable JobID is incremented by one at step (308). Then, the procedure returns to step (305) to treat the next print job.

On the other hand, if the variable JobID is beyond the final ID (maximum ID of the print job that the printing apparatus 102 holds) at step (305), namely, if there is no more print job, the procedure transfers to step (309). At step (309), the procedure waits for a selection of any of the print jobs displayed on the panel, or an input of a cancel instruction.

And at step (310), it is determined whether or not any of the print jobs displayed on the panel is selected. If no print job is selected, the procedure returns to step (301). If any print job is selected, the printing for the print job corresponding to the selected print job name is performed at step (311). Further, the print charge of the print job is deducted from the balance at step (312).

Herein, the print charge of the print job depends on the color print, the number of prints, the paper size used for printing, and the kind of paper.

At step (313), the print job for which the printing is completed is deleted from the table information, and the document file of the print job is deleted. Then, the procedure returns to step (301). In this manner, if the printing is completed or the print job is not selected, the procedure returns to the top to continue the above process. The print job for which the printing is completed may be deleted every time, or deleted collectively at the close of the day. The methods of deleting the print job may include erasing or invalidating the attribute information of the print job, and erasing or invalidating the document file of the print job.

The user can input the user name and the password by manipulating a liquid crystal touch panel in the operation panel section 113 as shown in FIG. 1.

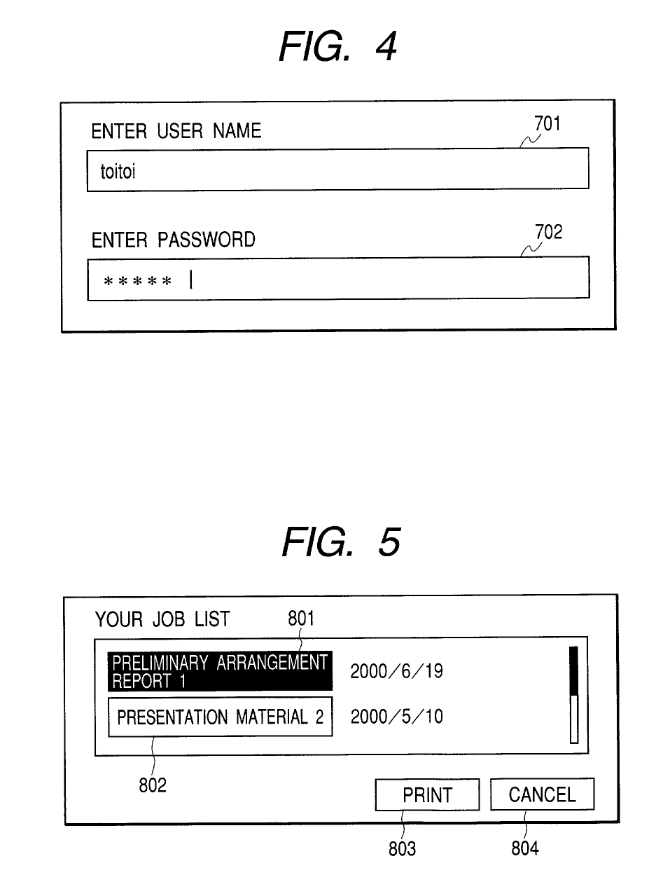

FIG. 4 is a view showing an input screen displayed on the operation panel section 113 as shown in FIG. 1.

In FIG. 4, reference numeral 701 denotes an input area for the user name, and 702 denotes an input area for the password. The password is displayed usually in asterisk not to be seen by other persons.

Referring to FIG. 2, in a case where the user name “toitoi” is input at step (302) as shown in FIG. 3, and the password “aiueo” is input at step (303), the print jobs with a job name of “preliminary arrangement report 1” and a job name of “presentation material 2” are detected is in the retrieval processing from steps (305) to (308). And these job names are displayed on the operation panel section 113 to be selectable by the user. Also, in a case where the user name “yochy” is input and the password “foobar” is input, the job name “specification” is only displayed and the job name “digital camera image” is not displayed because the password is not coincident. In this manner, the job name for which the user name is coincident but the password is different is not displayed on the panel and not selectable.

FIG. 5 is a view showing a selection screen displayed on the operation panel 113. On this selection screen, the job name for the print job corresponding to the user name and the password is displayed.

In FIG. 5, reference numeral 801 denotes the job name being selected. The selected job name is displayed in reverse character string. Reference numeral 802 denotes the job name not selected. By depressing an up or down key on the operation panel 113, the selection can be changed. When a list of job names is not contained in one screen, the selection scope can be widened by using a scroll bar.

If a print execution button 803 is depressed in a state where any job name is selected, the printing apparatus 102 performs step (311) to start the print operation of the print job corresponding to the selected job name. Moreover, if a cancel button 804 is depressed, the display of the operation panel 113 returns to the screen display as shown in FIG. 4.

With the above operation, the printing system of this embodiment allows everyone to input the print job, whereby if the print charge is paid before the actual printing, it is possible to provide a facility service, like the copying machine service.

In the above embodiment, the user can input the print job to the printing apparatus 102 without limit.

However, since the storage device 115 has a limited storage capacity, the limitless input of the print job gives rise to an overflow of the storage device 115, resulting in a problem that the print service can not be provided.

As its countermeasure, the print jobs that the printing apparatus 102 holds are given the priority level, and if there occurs an overflow, the print job with lower priority level is breached, so that the storage device 115 has an empty capacity to continue the service.

For instance, in the print service, the print job is stored in the storage device 115 temporarily from the time when the user transmits the print job to the time when the print job is actually printed, and there is essentially no need that the print job is stored for a long time.

However, in reality, the unintended print job may remain due to a transmission error or an operation error of the print job, or because the user forgets transmitting the print job, whereby there is the possibility that old print jobs remain for an indefinite time.

In such cases, since the older jobs may be less necessary, the print job having an older creation time can be judged to have a lower priority level. The system configuration according to such a concept is shown in the following.

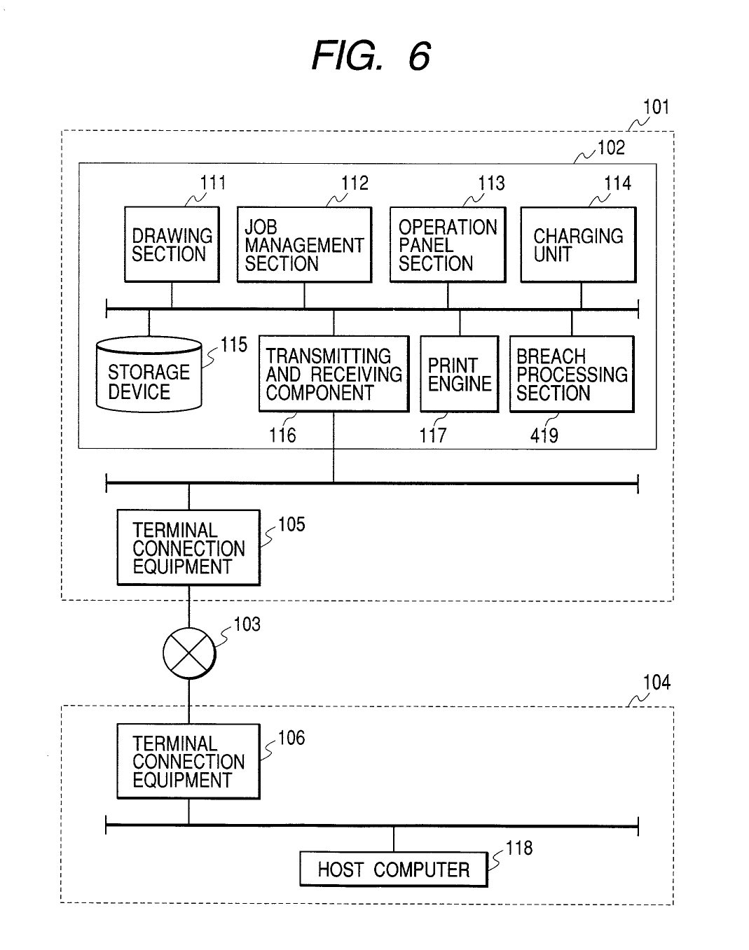

FIG. 6 is a block diagram for explaining a configuration of a printer system for managing the print job by appending a priority level to the print job. In FIG. 6, the same or like parts are designated by the same numerals as in FIG. 1.

In FIG. 6, reference numeral 419 denotes a breach processing section that is a module for performing a breach processing of the print job when an overflow occurs.

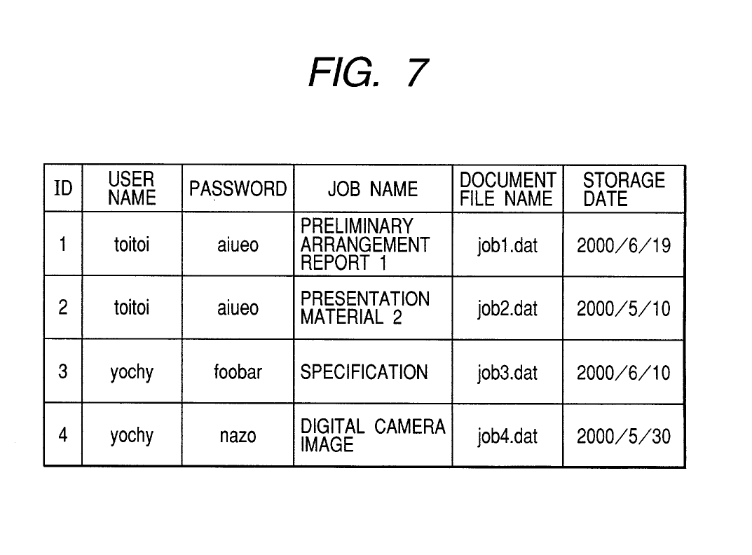

FIG. 7 is a table for explaining a configuration of table information generated by the job management section 112, in which the attribute of creation date (storage date) is appended to the table information of FIG. 2 to record the time when the printing apparatus 102 receives the print job and used as the parameter for the breach processing.

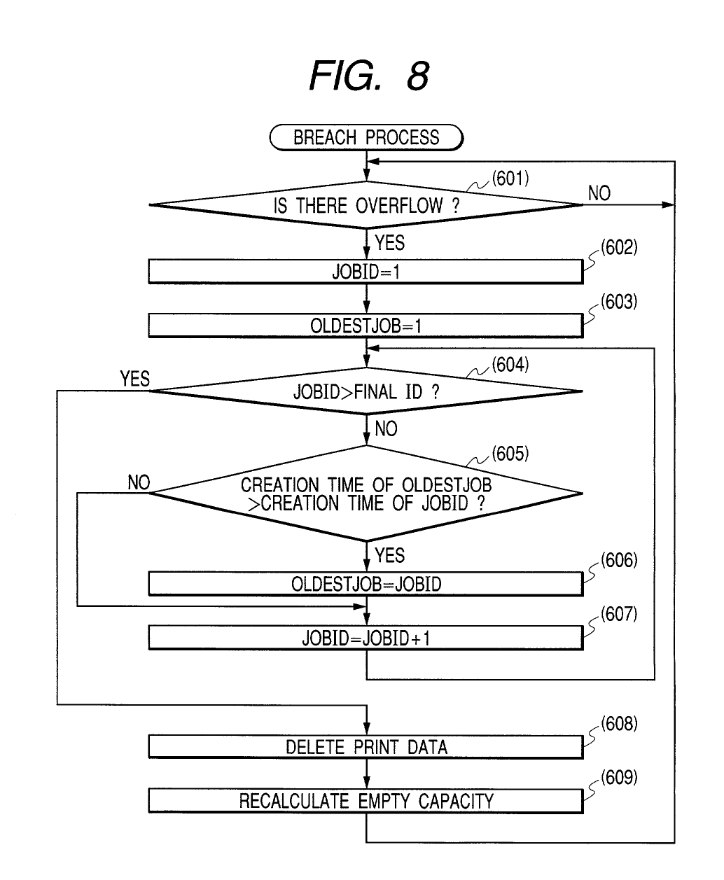

FIG. 8 is a flowchart showing one example of a second data processing procedure according to the invention, corresponding to an operation procedure of the breach processing section 419. Reference numerals (601) to (609) indicate each step.

The breach processing section 419 as shown in FIG. 6 is started upon initiating the printing apparatus 102. First of all, at step (601), it is monitored whether or not an overflow occurs. In this embodiment, the overflow occurs not when the data can not be actually written into the storage device 115, but when the empty capacity is below a predetermined size.

If no overflow occurs at step (601), the procedure returns to the top of the processing to continue to monitor the overflow. If any overflow occurs, the procedure proceeds to step (602) to retrieve the oldest job to be breached.

At step (602), the variable JobID is set to “1”, and at step (603), the variable OldestJob indicating the print job ID of the print job to be breached is initialized to “1”.

And at step (604), it is checked whether or not the retrieval is made till the final ID. If the retrieval is not made till the final ID, it is determined whether or not the creation time of the print job ID indicated by the variable JobID is older than the creation time of the print job ID indicated by the variable OldestJob than at step (605). If the answer is no (the creation time of the print job ID indicated by the OldestJob is older), the procedure transfers to step (607). If the creation time of the print job ID indicated by the variable JobID is older, the procedure proceeds to step (606). At step (606), the value of the variable JobID is overwritten on the variable OldestJob.

At step (607), the value of the variable JobID is incremented by one. Then, the procedure returns to step (604) to continue the retrieval.

On the other hand, if it is determined that all the print jobs have been examined at step (604), and because the variable OldestJob contains the oldest print job ID at the creation time, to breach the print job corresponding to the oldest print job ID, the print data of the corresponding print job is deleted at step (608). And at step (609), the empty capacity is detected or calculated, and then the procedure returns to the top.

In this manner, the oldest print job is breached to keep a limited capacity of the storage device 115, and continue the service.

In the above embodiment, an indication that the print job is breached may be notified by electronic mail, if the electronic mail address of the owner is registered as the attribute of the print job. In this case, at step (608), a mail address corresponding to the print job to be breached is read from the table information, and an electronic mail directed to the mail address and indicating that the print job is deleted is created and transmitted.

Also, the user may make a setting of whether or not the notification by an electronic mail is performed, and control the transmission of the electronic mail in accordance with the setting. In this case, the print job is deleted by transmitting the electronic mail to only the user who has made a setting of notifying the breach of print job by electronic mail, but notifying nothing to the user who has not made such setting.

In FIG. 8, the print data for the print job having older creation time or lower priority level is deleted, when an overflow occurs. However, in the case where the breach process is performed when the overflow occurs, the printing apparatus 102 may be inoperable or the working speed of the printing apparatus 102 may be decreased, because the breach process is started at the moment when the printing process is about to run. Also, the print data may be deleted after the lapse of a predetermined time since the reception may be deleted without regard to occurrence of the overflow.

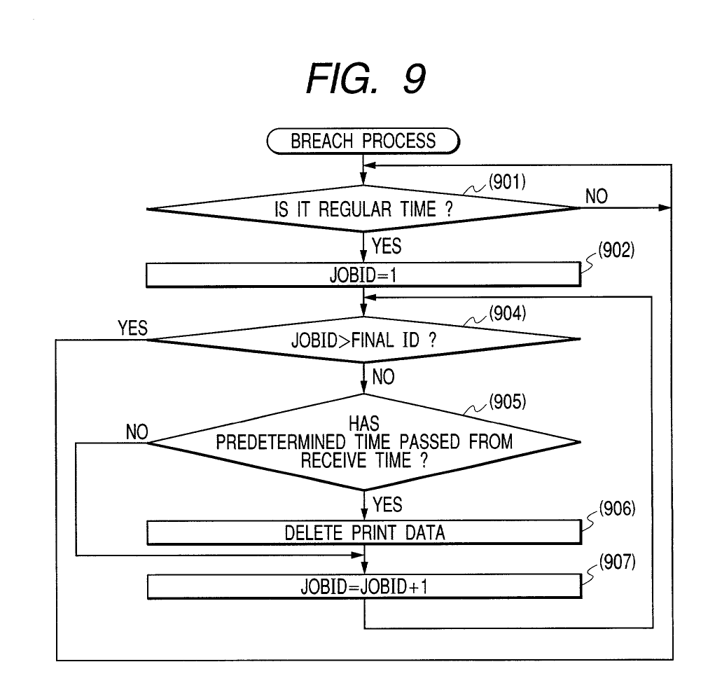

FIG. 9 is a flowchart showing one example of a third data processing procedure according to the invention. In the data processing procedure of the breach processing section 419, reference numerals (901) to (907) indicate each step.

The breach processing section 419 starts the process upon initiating the printing apparatus 102. First of all, at step (901), it is checked whether or not it is a scheduled time. The user can specify the scheduled time, for example, at the time when the printing apparatus is scarcely used (e.g., five o'clock in the early morning). A plurality of scheduled times may be specified, or the scheduled time may occur at every hour. If it is not the scheduled time, the following process is not performed.

If it is the scheduled time, the steps (902) to (907) are performed. First of all, at step (902), the variable JobID is set to 1. Next, at step (904), it is determined whether or not the value of the variable JobID is beyond the final ID. If so, the procedure returns to step (901).

If the value of the variable JobID is not beyond the final ID, it is determined whether or not a specific period of time has passed since the receiving time of the print job ID indicated by the variable JobID at step (905). The receiving time is stored in the table information, when the print data is received.

The specific period of time is defined as one week, for example. In this case, it is determined whether or not a difference between the receiving time and the current time is not less than one week. If the specific period of time has passed since the receiving time, the print data of the print job corresponding to the print job ID indicated by the variable JobID is deleted at step (906). If the specific period of time has not passed since the receiving time, the procedure proceeds to step (907). At step (907), the value of the variable JobID is incremented by one.

The breaching process of FIG. 9 decreases the possibility that the overflow occurs in the storage device, but when a number of print jobs of large data size are received in a short time, the overflow problem still remains. In this case, the breaching processes of FIGS. 8 and 9 may be performed in parallel. By combination of the breaching process at the scheduled time and the breaching process when the overflow occurs, the possibility of performing the breaching process during the use of the printing apparatus is reduced, whereby the service can be continued by breaching the print job more certainly.

In the above embodiment, the user decides uniquely the printing apparatus for printing the print job, and transmits the print job directly to that printing apparatus. Accordingly, the user can not change the printing apparatus for printing the print job after transmitting the print job. However, the user may want to firstly transmit the print job, and then decide the printing apparatus for printing the print job in some cases. For instance, the user may want to transmit the print data before leaving the house or the company, search a shop where the printing apparatus is installed at the destination, and receive the printed matter from the printing apparatus at the shop.

In the above embodiment, the print data is stored in the storage device of the printing apparatus. Since the printing apparatus is employed by many and unspecified persons, there is the fear that the evil-minded user may operate the printing apparatus to appropriate the print data of other users.

Also, in the above embodiment, each printing apparatus comprises the storage device for storing the print data. Accordingly, in a case where the printing apparatus is installed-at a number of shops, it is difficult in respect of the costs that each printing apparatus has a mass storage.

An embodiment that can solve such problems will be described below.

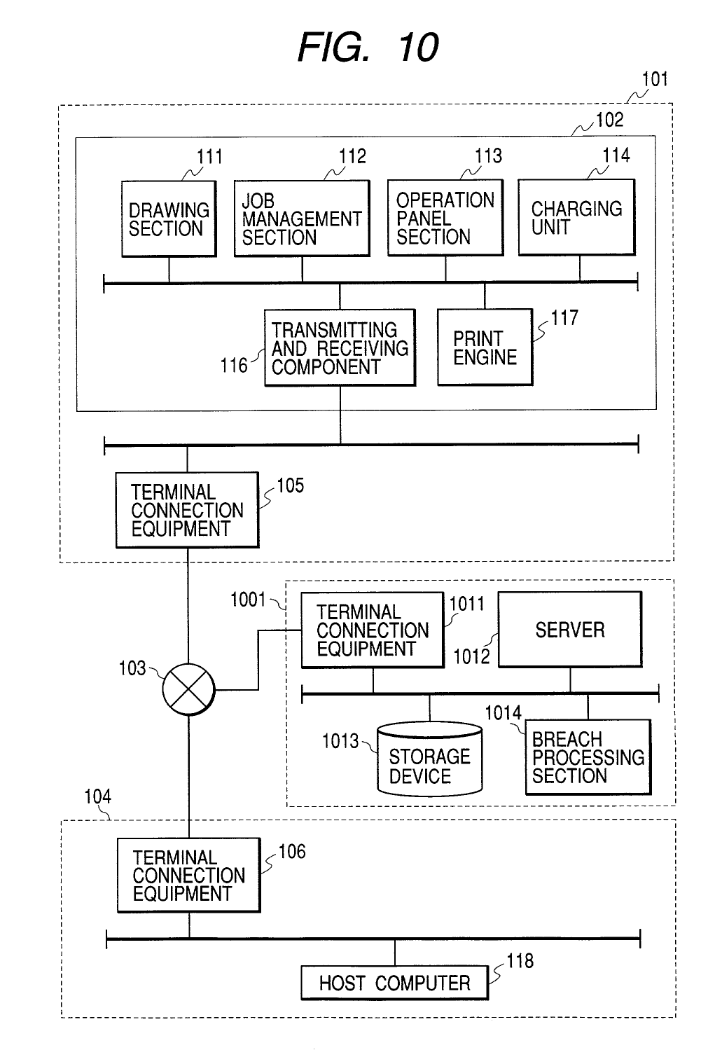

FIG. 10 is a block diagram for explaining a configuration of a printer system having a server. This printer system is divided into three blocks, including at least one output center system 101 for performing the charge and the actual printing, a server system 1001 for temporarily storing the print job, and a user system 104 for the user to instruct the printing. In the printer system of FIG. 10, the server system 1001 is added to the system of FIG. 1. Therefore, other parts are not described.

In the user system 104, at the time of transmitting the print job, the host computer 118 prompts the user to enter the user name, the password and the job name, appends the input contents as the job attribute information to the print job, and transmits the print job to the server 1012.

And the print job is transmitted through the terminal connection device 106 via the Internet 103 to the server 1012.

The server system 1001 temporarily stores the print job from the user, and transmits the print job to the printing apparatus of requester, upon a request from the printing apparatus. The terminal connection device 1011 is connecting means to the Internet. The server 1012 stores the print job transmitted from the user system 118 in the storage device 1013, searches for the print job corresponding to the user name and password input into the printing apparatus 102 in response to the request from the printing apparatus 102, and passes the list of the print job to the printing apparatus 102. Further, it has a role of transmitting the print job to the printing apparatus 102 in accordance with a print instruction from the printing apparatus 102. The storage device 1013 stores the print job in accordance with a request from the server 1012, and outputs the list of print job, or outputs the print job. The breach processing section 1014 detects an overflow of the storage device 1013 in the same manner as the breach processing section 419 of FIG. 6 and performs the breaching process for the print job.

The printer system of FIG. 1 and the printer system of FIG. 10 are different in that the host computer 118 of FIG. 10 does not input the print job directly into the printing apparatus 102, but transmits the print job to the server 1012 once. Accordingly, there is no need that the user decides which printing apparatus is employed to print the print job when the user transmits the print job.

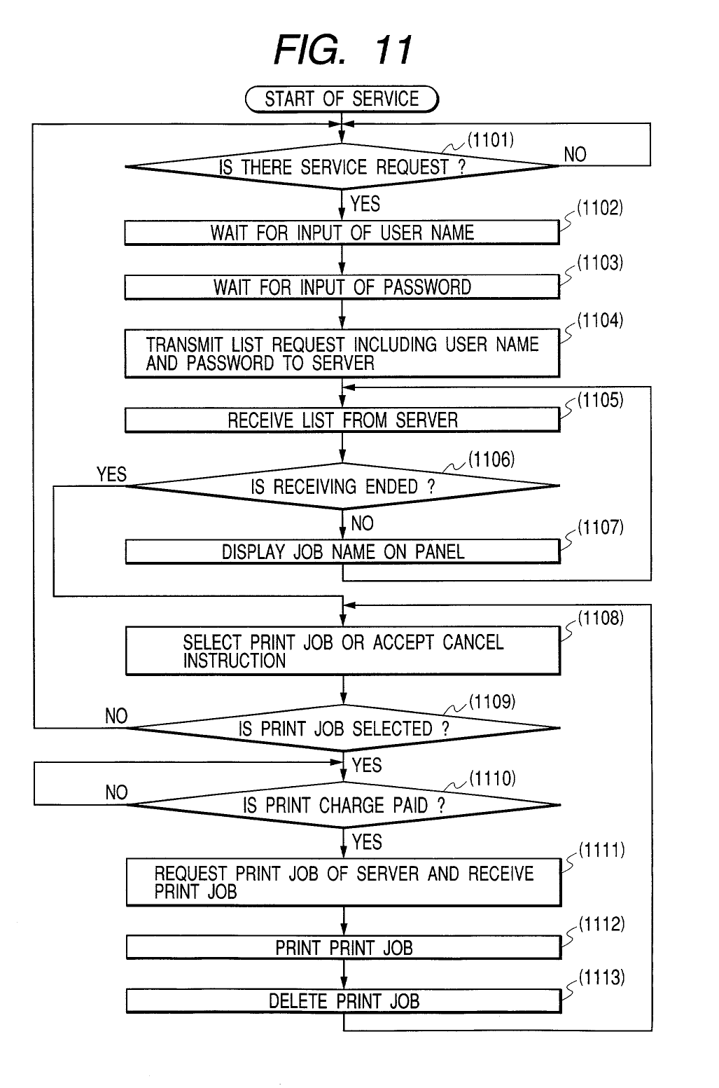

FIG. 11 is a flowchart showing one example of a fourth data processing procedure in the printing apparatus of FIG. 10. Reference numerals (1101) to (1112) denote each step.

This process is started when the printing apparatus 102 is initiated, and continues to operate till the power is shut off.

First of all, at step (1101), it is determined whether or not the user makes a request to employ the print service. If the user makes the request to employ the print service, a screen as shown in FIG. 4 appears on the display panel. The procedure waits for an input of the user name at step (1102), and waits for an input of the password at step (1103).

In the printer system of FIG. 10, the print job is possessed by the server system 1001, rather than the printing apparatus. Therefore, at step (1104), the input user name and password are transmitted to the server 1012, and the list information of the print job corresponding to the user name and password is requested to the server 1012. This request is hereinafter referred to as a list request.

Then, the server 1012 searches for the print job from the table information in accordance with the user name and password received, and transmits the information regarding the corresponding print job to the printing apparatus 102. Accordingly, the printing apparatus 102 receives the information regarding the print job at step (1105). The information regarding the print job includes the job ID and the job name for the print job.

The printing apparatus 102 receives the information regarding the print job in succession, and displays the job name for the print job in the list on the display panel. FIG. 5 shows one example of the display contents. If all the list information is received, the procedure proceeds to step (1108). Though the server 1012 transfers the information regarding the print job in succession here, it may transfer the list information as to the list of relevant print jobs at once. In this case, the printing apparatus 102 receives the list information, and displays the job name on the display panel at once.

At step (1108), a “print execution” button 803 is depressed by selecting at least one print job on the screen of FIG. 5, or a “cancel” button 804 is depressed. If the “cancel” button 804 is depressed, the procedure returns to step (1101).

If the “print execution” button is depressed by selecting the print job, it is checked whether or not the print charge has been paid at step (1110). Unless the print charge has not been paid, the procedure waits till the print charge is paid.

For instance, if the charge device 114 detects that the coin is input and the print charge is paid, the procedure goes to step (1111). At step (1111), the selected print job is requested of the server 1012, and the print data for the selected print job is received from the server system 1001. The request for the selected print job is referred to as a job request. And at step (1112), the printing process for the print job is executed. After the printing process for the print job is executed, the print data for the print job is deleted at step (1113).

In this manner, the list information as to the list of print jobs is received, the print job is selected from the list by the user, and the print data is received, whereby the print data is not stored in the printing apparatus for a long time. Therefore, there is less chance that one user operates the printing apparatus, and appropriates the print data of other user.

There is no need of providing a mass storage for the printing apparatus to receive only the print data for the selected print job from the server, whereby the costs can be reduced.

After the user inputs the user name and password into the printing apparatus and pays a print charge, the print data is transferred to the printing apparatus, whereby the user can instruct the printing apparatus in a desired site to print the print job at a desired time. Also, the charge process is easily made.

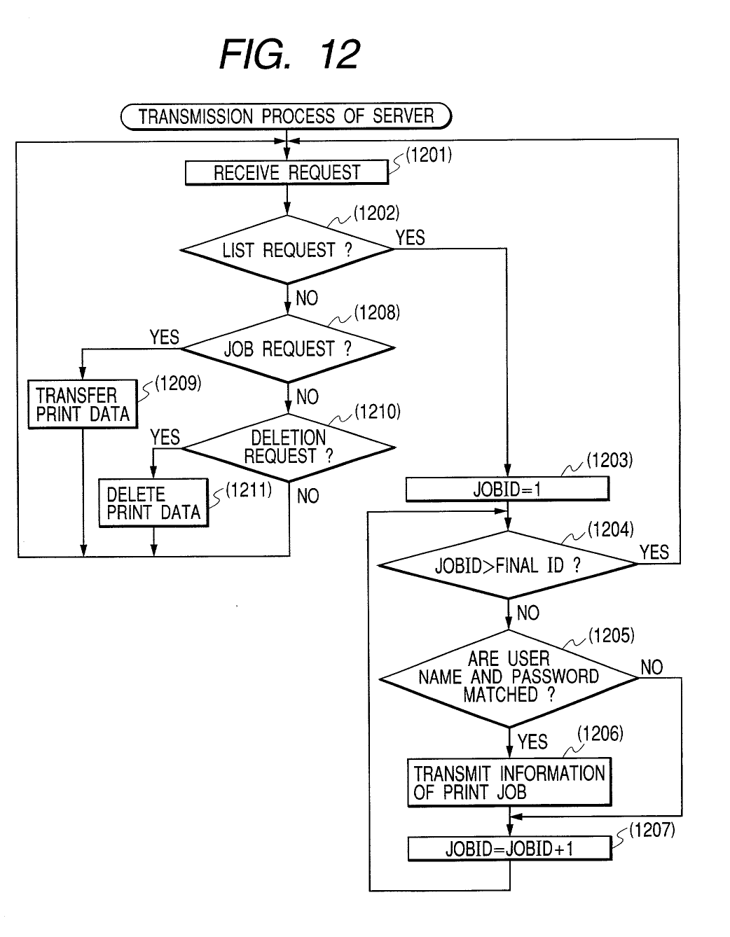

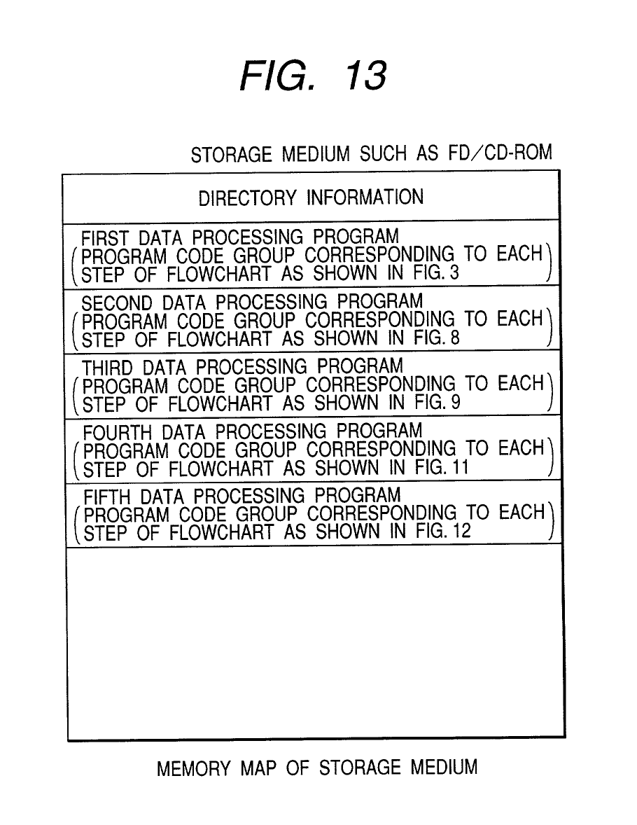

Next, the transmission process of the server 1012 will be described below. FIG. 12 is a flowchart showing one example of a fifth data processing procedure in the server according to the invention, in which the server 1012 transmits the print data. This operation is started when the server 1012 is initiated, and continues till the power is shut off.

First of all, at step (1201), the server waits to receive a processing request from the printing apparatus. If the server receives the processing request, it is checked whether or not the request is a list request at step (1202).

In a case of the list request, the variable JobID is initialized to 1 at step (1203), and the print job corresponding to the user name and password transmitted with the list request is retrieved. At step (1204), it is determined whether or not the value of the variable JobID is greater than the final ID. If so, all the print jobs are examined, and the procedure returns to step (1201).

If the value of the variable JobID is not greater than the final ID, it is checked whether or not the user name and password of the print job ID indicated by the variable JobID are matched with the user name and password transmitted from the printing apparatus 102 at step (1205). If not, the procedure goes to step (1207). If matched, the job name and the print job ID for the print job having the print job ID indicated by the variable JobID are transmitted to the printing apparatus 102.

At step (1207), the value of the variable JobID is incremented by one.

On the other hand, if the processing request from the printing apparatus 102 is not the list request, it is checked whether or not the processing request is a job request at step (1208). In a case of the job request, the print data of the print job designated by the job request is transferred to the printing apparatus 102 at step (1209). The designation of the print job is made by the print job ID.

If it is checked that the processing request is not the job request at step (1208), it is determined whether or not the request from the printing apparatus is a deletion request at step (1210). This deletion request is made when the user specifies the deletion of the print job by operating the operation panel 113 of the printing apparatus 102. In a case of the deletion request, the print data of the print job designated by the deletion request is deleted from the storage device 1013 at step (1211). The designation of the print job is made by the print job ID.

In this manner, since the server holds the print data of the print job, the user can gain access to the printing apparatus placed anywhere to make the printing. Also, since only the print data of the print job selected by the user is transferred from the server to the printing apparatus, the network has a communication amount suppressed to the minimum, with least chance that the print data is appropriated by other users.

The printing apparatus 102 of FIG. 1, 6 or 10 may be constituted of the printing apparatus and the printer controller. For instance, the print engine 117 is contained in the printing apparatus, and the storage device 115 and the operation panel 113 are contained in the printer controller. In this case, the printer controller may be an information processing device such as the host computer, a workstation, or a personal computer.

The printing apparatus 102 may be an image processing devices having the printing function, such as a copying machine, a composite machine, an ink jet printer, a laser beam printer or a FAX apparatus.

Referring to FIG. 13, the configuration of a data processing program that can be read by the printing system according to the invention will be described below.

FIG. 13 is a table showing a memory map of a storage medium storing various data processing programs that are readable in the printer system according to the invention.

Not particularly shown, the information managing a group of programs stored in the storage medium, for example, version information and author name, is also stored, and the information dependent on the OS at the program reading side, for example, an icon for displaying the identification of program, may be stored.

Moreover, the data dependent on various programs is managed under the directory. Also, the programs for installing various programs in the computer or a decompression program used when the program to be installed is compressed may be stored.

In this embodiment, the functions may be fulfilled on the host computer by the programs installed from the outside. In this case, a group of information including the programs may be supplied from the storage medium such as CD-ROM, flash memory or FD, or from the external storage device via the network to the output device. The invention is also applicable to this case.

To attain the objects of the invention, it is needless to say that the storage medium storing the program codes of the software for implementing the functions of the previous embodiment may be supplied to the system or apparatus, and the computer (or CPU or MPU) for the system or apparatus reads and executes the program code.

In this case, the program code itself read from the storage medium implements the new function of the invention, and the storage medium storing the program code constitutes the invention.

Examples of the storage medium useful to supply the program code may include a floppy disk, a hard disk, an optical disk, an optical magnetic disk, a CD-ROM, a CD-R, a magnetic tape, a non-volatile memory card, a ROM, and an EEPROM.

It will be appreciated that the functions of the above embodiment are implemented when the computer executes the program code read from the storage medium, or the OS (Operating System) working on the computer performs partially or totally the actual processing in accordance with the program code.

Furthermore, it will be appreciated that the functions of the above embodiment are also implemented when a CPU provided in a function expansion board or a function expansion unit performs partially or totally the actual processing in accordance with the program code that is read from the storage medium and written in the function expansion board inserted into an expansion slot of the computer or a memory equipped with the function expansion unit connected to the computer.

In the above embodiment, the server system is described in which the information is collectively stored in the storage device of the server. However, the jobs set up by the user may be accumulated and managed in a memory area for the home page of a provider with which the user has a contract, and a job for the user ID may be authenticated at any time in the output center, and made printable, in which the charge process for paying the print charge partially or totally is performed based on whether or not to print the advertisement information provided from the provider.

In the charge process, the cash, prepaid card medium, or other media usable on the network may be employed to suit the convenience of the user. For some contract users, the print condition of the user may be managed to permit the dealings on credit such as the monthly collective transfer or collective payment.

The job transferred from the information processing apparatus may have synthetic information appended to synthesize it with the jobs from other users, so that the jobs from a plurality of users may be printed as one job.

Furthermore, the user interface may be configured in such a way that the print cost to be paid is presented depending on the kind of paper or print condition (perfect printing, stapling, binding, or color print) for use with the print engine

Further, when the jobs are accumulated in the server, the zip code for the user may be appended to the attribute information, whereby an output center candidate located in proximity to the server is explicitly indicated to return the confirmation information when the job is received.

As described above, according to this invention, in the case where the print service for printing the print data transferred from the host computer of the user is provided by the printer at the shop, the charge process is made certainly.

Also, in the case where the print service is provided, the print data of a certain user is prevented from being simply appropriated by other users, or printed in accordance with an instruction from other users, whereby the secrecy of the print data is kept.

Particularly, the user receives the list information indicating a list of print jobs to select a print job from the list, and receives the print data, whereby the print data is not stored in the printing apparatus for the long time. Hence, there is less chance that the certain user appropriates the print data from another user by operating the printing apparatus.

Since the print data of the selected print job is only received from the server, there is no need that the printing apparatus is provided with a mass storage, whereby the costs are reduced.

After the user inputs the user name and password, and pays a print charge, the print data is transferred to the printing apparatus, whereby the user can instruct the printing apparatus in a desired site to print the print job at a desired time. Also, the charge process is facilitated.

What is claimed is:

1. A printer controller for controlling the printing of print data transferred from an external device and stored, comprising:
storage means for storing the print data and authentication information corresponding to the print data;
input means for enabling a user to input the authentication information to print the print data;
display control means for displaying a list of print data corresponding to the input authentication information on a display panel by collating the authentication information input by said input means with the authentication information stored in said storage means;
selection means for enabling the user to select at least one print data from the list of print job displayed on said display panel; and
control means for controlling the printing of the selected print data after confirming that a print charge for printing the print data selected by said selection means is paid.

2. The printer controller according to claim 1, wherein said storage means has breaching means for breaching the print job having a lower priority level that is retrieved, upon detecting that said storage means can not store the print data anymore.

3. The printer controller according to claim 2, wherein the print data having lower priority level means the print data having an older receiving time.

4. The printer controller according to claim 2, further comprising notification means for notifying a destination address set up for the breached print data that the print data is breached, when the print data is breached by said breaching means.

5. The printer controller according to claim 1, further comprising judgement means for judging whether or not a predetermined period has passed since the print data is received, and breaching means for breaching the print data, if said judgement means judges that the predetermined period has passed since the print data is received.

6. A printer controller that can communicate with an information processing apparatus for storing the print data transferred from an external device and authentication information corresponding to the print data, comprising:
input means with which the user inputs the authentication information to print the print data;
acquisition means for acquiring the information indicating the print data corresponding to the input authentication information from said information processing apparatus by transmitting the authentication information input by said input means to said information processing apparatus;
display control means for displaying a list of print data corresponding to the input authentication information on a display panel in accordance with the information acquired by said acquisition means;
selection means with which the user selects at least one print data from the list of print data displayed on said display panel;
data acquisition means for acquiring the selected print data from said information processing apparatus by requesting the print data selected by said selection means of said information processing apparatus; and
control means for controlling the printing of the print data acquired by said data acquisition means after confirming that a print charge for printing the print data selected by said selection means is paid.

7. The printer controller according to claim 6, wherein said data acquisition means requests the selected print data of said information processing apparatus after confirming that the print charge for printing the print data selected by said selection means is paid.

8. The printer controller according to claim 6, wherein said acquisition means acquires the information indicating a name given to the print data corresponding to the input authentication information.

9. The printer controller according to claim 6, wherein said data acquisition means receives the selected print data from said information processing apparatus by transmitting the information indicating the selected print data to said information processing apparatus.

10. The printer controller according to claim 6, wherein said control means deletes the acquired print data after printing the print data acquired by said data acquisition means.

11. A data processing method for providing a print service using a storage device for storing the print data transferred from an external device and the authentication information corresponding to the print data, and a printer, comprising the steps of:
displaying a list of print data corresponding to the input authentication information on a display panel by collating the authentication information input by the user to print the print data with the authentication information stored in said storage means;
recognizing at least one print data selected by the user from the list of print job displayed on said display panel; and
controlling the printer to perform the printing of the selected print data after confirming that a print charge for printing the selected print data is paid.

12. The data processing method according to claim 11, further comprising the step of breaching the print job having a lower priority level that is retrieved, upon detecting that said storage means can not store the print data anymore.

13. The data processing method according to claim 12, wherein the print data having lower priority level means the print data having an older receiving time.

14. The data processing method according to claim 12, further comprising the step of notifying a destination address set up for the breached print data that the print data is breached, when the print data is breached by said breaching means.

15. The data processing method according to claim 11, further comprising the step of judging whether or not a predetermined period has passed since the print data is received, and breaching the print data, if it is judged that the predetermined period has passed since the print data is received.

16. A data processing method for providing a print service using an information processing apparatus for storing the print data transferred from an external device and the authentication information corresponding to the print data, and a printer, comprising the steps of:
acquiring the information indicating the print data corresponding to the input authentication information from said information processing apparatus by transmitting the authentication information input by the user to print the print data to said information processing apparatus;
displaying a list of print data corresponding to the input authentication information on a display panel in accordance with the acquired information;
acquiring the selected print data from said information processing apparatus by requesting at least one print data selected by the user from the list of print data displayed on said display panel of said information processing apparatus; and
controlling said printer to perform the printing of the acquired print data after confirming that a print charge for printing the selected print data is paid.

17. The data processing method according to claim 16, further comprising the step of requesting the selected print data of said information processing apparatus after confirming that the print charge for printing the selected print data is paid.

18. The data processing method according to claim 16, further comprising the step of acquiring the information indicating a name given to the print data corresponding to the input authentication information from said information processing apparatus.

19. The data processing method according to claim 16, further comprising the step of receiving the selected print data from said information processing apparatus by transmitting the information indicating the selected print data to said information processing apparatus.

20. The data processing method according to claim 16, further comprising the step of deleting the acquired print data from the printer after the end of printing the acquired print data.

21. A control program that is run on a computer for controlling the printing of the print data transferred from an external device and stored, comprising:
a storage step of storing the print data and the authentication information corresponding to the print data;
an input step of enabling the user to input the authentication information to print the print data;
a display control step of displaying a list of print data corresponding to the input authentication information on a display panel by collating the authentication information input at said input step with the authentication information stored at said storage step;
a selection step of enabling the user to select at least one print data from the list of print job displayed on said display panel; and
a control step of controlling the printing of the selected print data after confirming that a print charge for printing the print data selected at said selection step is paid.

22. A control program that is run on a computer for controlling the printing of the print data by communicating with an information processing apparatus in which the print data transferred from an external device and the authentication information corresponding to the print data are stored, comprising:
an input step of enabling the user to input the authentication means to print the print data;
an acquisition step of acquiring the information indicating the print data corresponding to the input authentication information from said information processing apparatus by transmitting the authentication information input at said input step to said information processing apparatus;
a display control step of displaying a list of print data corresponding to the input authentication information on a display panel in accordance with the information acquired at said acquisition step;
a selection step of enabling the user to select at least one print data from the list of print data displayed on said display panel;
a data acquisition step of acquiring the selected print data from said information processing apparatus by requesting the print data selected at said selection step of said information processing apparatus; and
a control step of controlling the printing for the print data acquired at said data acquisition step after confirming that a print charge for printing the print data selected at said selection step is paid.
